(19) United States
(12) Patent Application Publication
(10) Pub. No.: US 2008/0007951 A1
(43) Pub. Date: Jan. 10, 2008

(54) LED decorative lighting structure

(76) Inventor: Tsung-Wen Chan, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/480,948

(22) Filed: Jul. 6, 2006

(51) Int. Cl. F21V 29/00

(52) U.S. Cl. 362/267

(57) ABSTRACT

A LED decorative lighting structure comprises a plurality of LEDS. Each LED has two electric conductor blades which being directly made by cutting down from a strip of the same material. Each of the two conductor blades is equipped with a terminal which further includes a holding strip and an electric conducting strip. The holding strip is for fixing an outer insulation sheath of a conductor by pressing on it; while the conducting strip is for fixing and making connection with the metallic stranded core wires of the conductor. The holding strips and the electric conducting strips in both conductor blades are disposed in different height with each other so as to avoid shortcircuiting by accidental contact. The plurality of LED constructed as such can be arranged in series/parallel connection thereby forming a desired configuration of the LED decorative lighting structure according to the present invention.

### BACKGROUND OF THE INVENTION

1. Field of the Invention

The present invention relates to a LED decorative lighting structure, in particular, to a LED decorative lighting structure which has a firm construction with an excellent water tight and dust protection ability in compliance with IP66 international standards applicable to any environmental condition, and can be fabricated with a low production cost.

2. Description of the Prior Art

Conventionally, a decorative lighting structure is assembled with a string of miniature lamps connected in series or parallel so as to glitter or flash. In the case of an art exhibition, festival or ceremonial banquet, it always plays an important roll in the occasion.

A miniature incandescent lamp is the hero in the traditional decorative lighting. It has the inherent disadvantages of considerably large size, high power consumption accompanied with a high temperature, low resistance to the weather condition if installed in outdoor, besides, it has to occupy a large spacing for putting away when not in use. All these cause the decorative lighting formed of the miniature incandescent lamps to become an expensive and unwelcome practice.

Accordingly, it is a wise choice to replace the miniature incandescent lamp with LED. But it should be understood that the LED does not fit for use in general lighting application by reason of lacking in brightness. However, such a fatal drawback of LED has been gradually improved by progressing technology in the field of lighting engineering. The LED has its distinct advantage of compact and light, low power consumption and long lifespan features. It is the best selection as a light source instead of incandescent lamp.

The general LED decorative lighting structure prevalent nowadays is formed of inserting the individual LEDs into the sockets which have already been disposed in series or parallel in a circuit. However, except the polarity in the circuit should be carefully identified, the LED is difficult to be fixed to the socket without the aid of specially designed LED fixture to dependably connect its conductor blade with the circuit so as to overcome the unreliable contact by touching only. In addition, how to hermetically seal the LED lighting structure to keep out water and dust for use in outdoor to avoid possible failure that leads to shortening the lifespan of the product is another severe challenge.

For these defects noticeable on the present situation, an improvement is seriously required. The applicant has plunged into this matter with great efforts to studying and improving these defects and come up with a novel LED decorative lighting structure as provided in this invention.

### SUMMARY OF THE INVENTION

Accordingly, it is the main object of the present invention to provide a LED decorative lighting structure in which LED conductor blades are formed by cutting down from a strip of the same metallic material so as to eliminate a complicated production line and finishing process thereby minimizing the production cost.

Another object of the present invention is to provide a LED decorative lighting structure which has a simple layout and a stable construction so as to ensure a normal performance.

One more object of the present invention is to provide a LED decorative lighting structure which has an excellent water tight and dust protection ability in compliance with IP66 international standards applicable to any environmental condition.

To achieve these and other objects described above, the LED decorative lighting structure comprises a plurality of LEDs connected in series or parallel. Each LED has two electric conductor blades which has been directly cut down from a strip of the same metallic material. Each of the two conductor blades is equipped with a terminal which further includes a holding strip and an electric conducting strip. The holding strip is for fixing the outer insulation sheath of the circuit conductor by pressing thereon; while the conducting strip is for fixing and making electric connection with the metallic stranded core elements of the circuit conductor. The holding strip and the conducting strip in one conductor blade are disposed in different height with that of adjacent one so as to avoid short circuiting by accidental contact. After burying the individual LED die properly in its position and infusing the epoxy resin thereof, and making wire connections, the plurality of LED constructed as such are arranged in series or parallel connection thereby forming a stable and durable LED decorative lighting structure of the present invention.

### BRIEF DESCRIPTION OF THE DRAWINGS

The drawings disclose an illustrative embodiment of the present invention which serves to exemplify the various advantages and objects hereof, and are as follows:

FIG. 1 is a schematic layout view of the present invention;

FIG. 2 is a structural view of an individual LED according to the present invention;

FIG. 3 is an illustrative erected view showing the electrical connection of the present invention; and

FIG. 4 is an assembly view of the present invention.

### DETAILED DESCRIPTION OF THE PREFERRED EMBODIMENT

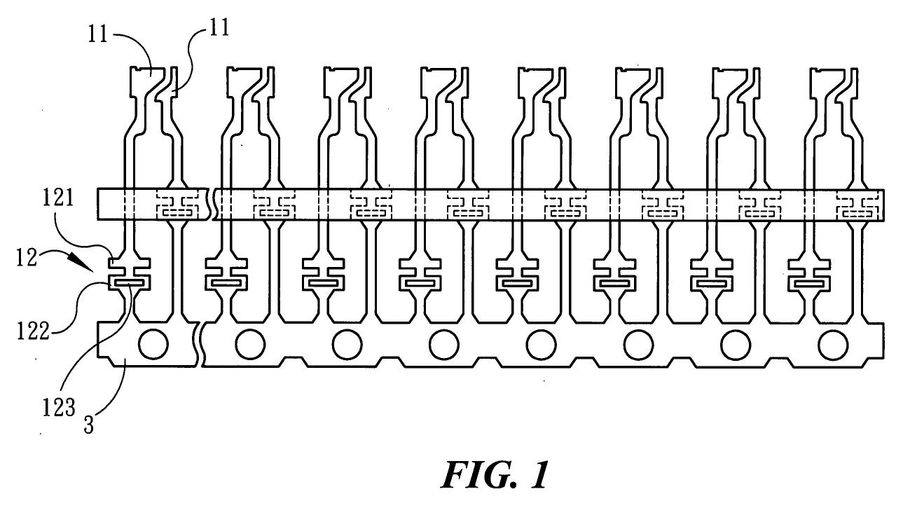

Referring to FIG. 1, the LED decorative lighting structure of the present invention comprises a plurality of LEDs 1 which being connected in series or parallel with conductors 2. Each of the LED 1 is provided with two conductor blades 11 cut down from a string of the same material 3 so that a large numbers of conductor blade 11 can be directly formed from the same material strip 3 thereby the production line is simplified and the production cost curtailed. Each conductor blade 11 has a terminal 12 which further includes a holding strip 121 and an electric conducting strip 122. The holding strip 121 is for fixing the outer insulation sheath 21 of the circuit conductor 2 by pressing thereon; while the conducting strip 122 is for fixing and making connection with the metallic stranded core elements 22 of the circuit conductor 2. The holding strips 121 and the conducting strips 122 in two adjacent conductor blades 11 are disposed in different height with each other so as to avoid shortcircuiting by accidental contact.

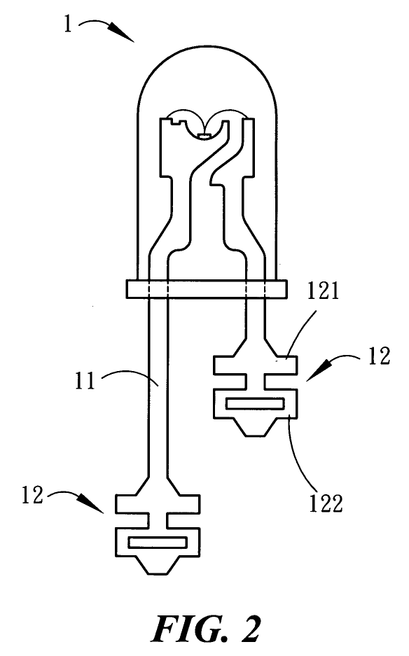

Referring to FIG. 2, after burying the individual LED dies appropriately in its position on the prepared conductor blades 11 cut to form from the material 3, and infusing the epoxy resin around the LEDs 1, a LED 1 together with tis terminal 12 is obtained.

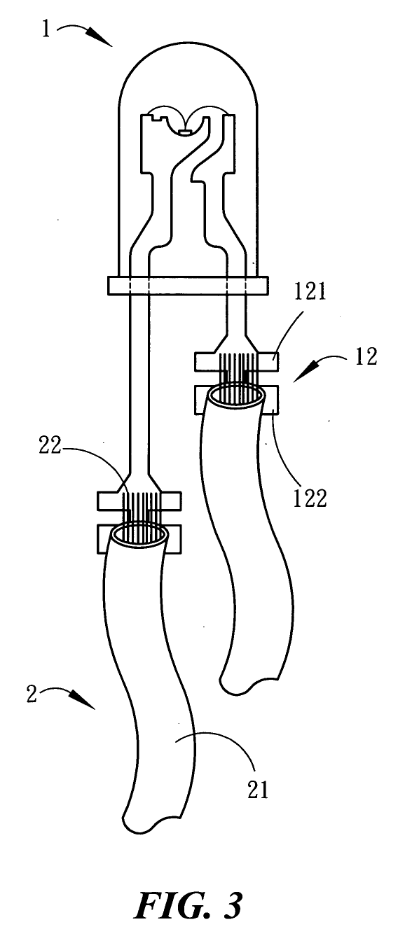

Referring to FIG. 3, when making electrical connection with the circuit conductor 2, at first the outer insulation sheath 21 thereof is peeled to exposed part of the metallic stranded core elements 22. Then the holding strip 121 of the terminal 12 of the LED 1 is squeezed against the insulation sheath 21 to press it in poison, whereas the exposed metallic stranded core elements 22 are squeezed by the conduction strip 122 to assure a tight electrical connection. The holding strip 121 and the conducting strip 122 of one conductor blade 11 is disposed in a different height with respect to that of the proximate conductor blade 11 so as to avoid possible electrical shortcircuiting by accidental contact with each other. Besides, a hollow slot 123 may be formed in the middle portion of either holding strip 121 or the conducting strip 122 so as to cause them easily bendable.

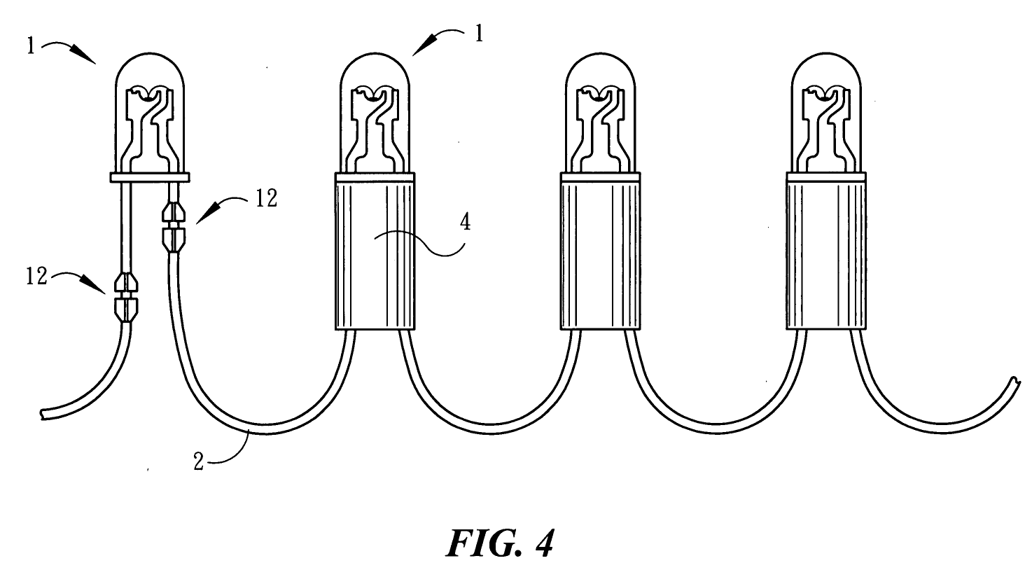

Referring to FIG. 4, the plurality of LEDs 1 are connected in series or parallel with the conductor 2 to configurate a desired LED decorative lighting structure of the present invention. A housing 4 is provided to cover the individual LED 1 so as to hermetically seal the LED and the metallic conducting part of the conductor 2 such that the terminal 12 and conductor 2 may be perfectly free from infringement of the rainfall, dust or other extraneous destructive attack to make the structure more durable and good looking.

Many changes and modifications in the above described embodiment of the invention can, of course, be carried out without depending from the scope thereof. Accordingly, to promote the progress in science and the useful arts, the invention is disclosed and is intended to be limited only by the scope of the appended claims.

What is claimed is:

1. A LED decorative lighting structure composed of a plurality of LEDs connected in series or parallel, each said LED having two electric conductor blades which being directly cut down to form from a strip of the same material; wherein each of the two conductor strips is provided with a terminal, said terminals of the adjacent conductor strips are disposed in a different height so as to avoid possible shortcircuiting between conducting part of said proximate conductor strips.

2. The lighting structure of claim 1, wherein said terminal further includes a holding strip and an electric conducting strip, said holding strip is for fixing the outer insulation sheath of the circuit conductor by pressing thereon; while said conducting strip is for fixing and making electric connection with the metallic stranded core elements of said circuit conductor.

3. The lighting structure of claim 2, wherein an hollow slot is formed in the middle portion of either said holding strip or said conducting strip so as to cause them easily bendable.

4. The lighting structure of claim 1, wherein a housing is provided to cover said LED so as to hermetically seal said LED and the electric conducting part of said circuit conductor.
